(19) United States
(12) Patent Application Publication
(10) Pub. No.: US 2026/0296924 A1
(43) Pub. Date: Oct. 1, 2026

(54) DISTILLATION SYSTEM PRESSURE CONTROL SYSTEM AND METHOD

(71) Applicant: HONEYWELL INTERNATIONAL INC., Charlotte, NC (US)

(72) Inventors: Matthew Dunn, Phoenix, AZ (US); Kevin Dittmar, Phoenix, AZ (US); Jeffrey Maldonado, Phoenix, AZ (US)

(73) Assignee: HONEYWELL INTERNATIONAL INC., Charlotte, NC (US)

(21) Appl. No.: 19/083,936

(22) Filed: Mar. 19, 2025

(51) Int. Cl. C02F 1/04

(52) U.S. Cl. CPC C02F 1/04; C02F 2201/004; C02F 2201/005; C02F 2209/02; C02F 2209/03; C02F 2209/40

(57) ABSTRACT

A distillation system pressure control system includes a tank, a diffuser, a valve, a pressure sensor, and a valve control. The tank has an inner volume, and a divider wall divides the inner volume into a main chamber and a settling chamber. The main chamber has at least a fluid inlet port and an exhaust gas inlet port, and the settling chamber has at least an exhaust gas outlet port. The diffuser is disposed within the main chamber and is adapted to receive exhaust gas discharged from a gas turbine engine. The valve is mounted on the exhaust gas outlet port is movable between a closed position and a plurality of open positions. The pressure sensor senses pressure within the tank. The valve control supplies valve commands to the valve based on the pressure sensor signal, to control the pressure in the tank.

### TECHNICAL FIELD

The present disclosure generally relates to distillation systems, and more particularly to a system and method for controlling pressure in a distillation system.

### BACKGROUND

Various industrial processes, including hydraulic fracturing (i.e., fracking), produce wastewater. The wastewater that is produced may include dissolved salts, metals, and other contaminants. Preferably, this wastewater undergoes a treatment process to remove the dissolved salts, metals, and other contaminants so that the recovered, clean water can be reused in future fracking operations or various other purposes such as, for example, agricultural irrigation. Various treatment processes are used to treat such wastewater. These include membrane filtration (like reverse osmosis), chemical precipitation, advanced oxidation processes, and distillation.

A typical distillation process involves heating the wastewater, which separates the water from the dissolved salts, metals, and other contaminants. The water vapor is then condensed to produce clean water for reuse. One particular distillation system that has been proposed is to use the exhaust gas from a gas turbine engine to heat the wastewater within a tank. However, if the pressure within the tank is not controlled sufficient accuracy, heat transfer between the wastewater and exhaust gas can be adversely impacted. Additionally, if the pressure is not controlled during shutdown of the gas turbine engine, water may backflow into the tank.

Hence, there is a need for a distillation system that uses exhaust gas from a gas turbine engine to treat wastewater in a tank and that control the pressure in the tank to thereby prevent excessive pressure during operation and/or prevent backflow during engine shutdown. The present disclosure addresses at least this need.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

In one embodiment, a distillation system pressure control system includes a tank, a diffuser, a valve, a pressure sensor, and a valve control. The tank has a first end wall, a second end wall, a front wall, a back wall, a top wall, and a bottom wall that together define an inner volume. A divider wall is disposed within the tank and divides the inner volume into a main chamber and a settling chamber. The main chamber has at least a fluid inlet port and an exhaust gas inlet port, and the settling chamber has at least an exhaust gas outlet port. The divider wall has at least one opening formed therein that provides fluid communication between the main chamber and the settling chamber. The diffuser is disposed within the main chamber and is coupled to the exhaust gas inlet port. The diffuser is adapted to receive exhaust gas discharged from a gas turbine engine. The valve is mounted on the exhaust gas outlet port and is configured, in response to valve commands, to move between (i) a closed position, in which the settling chamber is isolated from an ambient environment external to the tank, and (ii) a plurality of open positions, in which the settling chamber is in fluid communication with the ambient environment. The pressure sensor is coupled to the tank and is configured to sense pressure within the inner volume and supply a pressure sensor signal representative thereof. The valve control is in operable communication with the pressure sensor and the valve. The valve control is coupled to receive the pressure sensor signal from the pressure sensor and is configured to supply the valve commands to the valve based at least in part on the pressure sensor signal, to thereby control the pressure within the inner volume.

In another embodiment, a distillation system pressure control system includes a tank, a diffuser, a valve, a pressure sensor, a temperature sensor, and a valve control. The tank has a first end wall, a second end wall, a front wall, a back wall, a top wall, and a bottom wall that together define an inner volume. A divider wall is disposed within the tank and divides the inner volume into a main chamber and a settling chamber. The main chamber has at least a fluid inlet port and an exhaust gas inlet port, and the settling chamber has at least an exhaust gas outlet port. The divider wall has at least one opening formed therein that provides fluid communication between the main chamber and the settling chamber. The diffuser is disposed within the main chamber and is coupled to the exhaust gas inlet port. The diffuser is adapted to receive exhaust gas discharged from a gas turbine engine. The valve is mounted on the exhaust gas outlet port and is configured, in response to valve commands, to move between (i) a closed position, in which the settling chamber is isolated from an ambient environment external to the tank, and (ii) a plurality of open positions, in which the settling chamber is in fluid communication with the ambient environment. The pressure sensor is coupled to the tank and is configured to sense pressure within the inner volume and supply a pressure sensor signal representative thereof. The temperature sensor is coupled to the tank and is configured to sense temperature within the inner volume and supply a temperature sensor signal representative thereof. The valve control is in operable communication with the pressure sensor, the temperature sensor, and the valve. The valve control is coupled to receive the pressure sensor signal from the pressure sensor and the temperature signal from the temperature sensor and is configured to supply the valve commands to the valve based at least in part on the pressure sensor signal and the temperature sensor signal, to thereby control the pressure within the inner volume.

In yet another embodiment, a method of controlling pressure in a distillation system is provided for a system that comprises a tank, a diffuser, a gas turbine engine, and a valve, wherein (i) the tank has a first end wall, a second end wall, a front wall, a back wall, a top wall, and a bottom wall that together define an inner volume, a divider wall disposed within the tank and dividing the inner volume into a main chamber and a settling chamber, the main chamber having at least a fluid inlet port and an exhaust gas inlet port, the settling chamber having at least an exhaust gas outlet port, the divider wall having an opening formed therein that provides fluid communication between the main chamber and the settling chamber, (ii) the diffuser is disposed within the main chamber and is coupled to the exhaust gas inlet port, (iii) the gas turbine engine is in fluid communication with the exhaust gas inlet port and is configured, during operation thereof, to discharge exhaust gas into the main chamber via the diffuser, and (iv) the valve is mounted on the exhaust gas outlet port and movable to a valve position. The method includes the steps of: sensing pressure within the inner volume of the tank via a pressure sensor that is coupled to the tank; and controlling, via a valve control in operable communication with the pressure sensor and the valve, the position of the valve based at least in part on the pressure sensor signal, to thereby control the pressure within the inner volume.

Furthermore, other desirable features and characteristics of the distillation system pressure control system and method will become apparent from the subsequent detailed description and the appended claims, taken in conjunction with the accompanying drawings and the preceding background.

### BRIEF DESCRIPTION OF DRAWINGS

The present disclosure will hereinafter be described in conjunction with the following drawing figure, wherein like numerals denote like elements, and wherein:

FIG. 1 depicts a simplified functional schematic diagram of one embodiment of a distillation system; and

FIG. 2 depicts a process, in flowchart form, of controlling pressure in the distillation system of FIG. 1.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

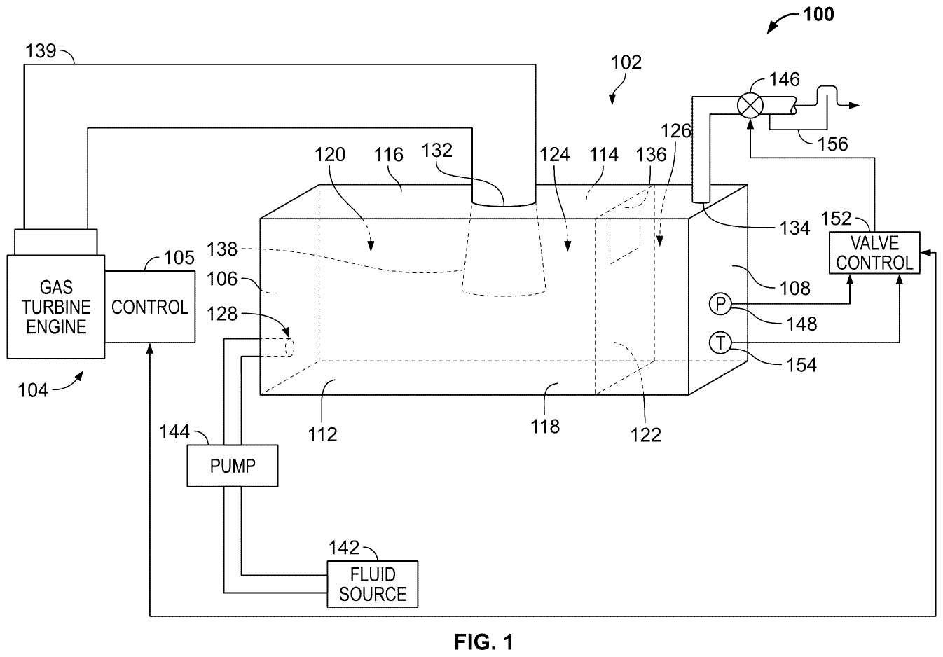

Referring now to FIG. 1, a simplified functional schematic diagram of one embodiment of a distillation system 100 is depicted and includes a tank 102 and a gas turbine engine 104. The tank 102 has a first end wall 106, a second end wall 108, a front wall 112, a back wall 114, a top wall 116, and a bottom wall 118. Together, the walls 106-116 define an inner volume 120.

As FIG. 1 also depicts, a divider wall 122 is disposed within the tank 102 and divides the inner volume 120 into a main chamber 124 and a settling chamber 126. The main chamber 124 has at least a fluid inlet port 128 and an exhaust gas inlet port 132, and the settling chamber 126 at least an exhaust gas outlet port 134. The divider wall 122 has a divider wall opening 136 formed therein that provides fluid communication between the main chamber 124 and the settling chamber 126. It should be noted that the exhaust gas outlet port 134 may be variously sized to meet desired performance characteristics. Preferably, however, it has a relatively large diameter to reduce the velocity of the gas being discharged and to reduce any entrained mist within the gas. In one embodiment, the exhaust gas outlet port 134 has a 36-inch diameter.

The gas turbine engine 104 is in fluid communication with the exhaust gas inlet port 132. During operation of the gas turbine engine 104, the gas turbine engine 104 discharges exhaust gas into the main chamber 124. And more specifically, the gas turbine engine 104 discharges exhaust gas into the main chamber 124 via a diffuser 138 that is disposed within the main chamber 124 and is coupled to the exhaust gas inlet port 132. In some embodiments, such as the one depicted in FIG. 1, an exhaust duct 139 is coupled between the gas turbine engine 104 and the exhaust gas inlet port 132. The exhaust duct 139, when included, is configured to direct the exhaust gas discharged from the gas turbine engine 104 into the exhaust gas inlet port 132.

Before proceeding further, it is noted that the distillation system 100, at least in the depicted embodiment, additionally includes an engine control 105 that is in operable communication with the gas turbine engine 104. The engine control 105 is configured to control the operation of the gas turbine engine 104. It will be appreciated that the gas turbine engine 104 may be implemented using any one of numerous types of gas turbine engines 104. In one particular embodiment, however, the gas turbine engine 104 is implemented using an auxiliary power unit (APU), such as an APU that is typically configured for use in commercial aircraft. It will additionally be appreciated that the engine control 105 may be implemented using any one of numerous known engine controls.

No matter how the gas turbine engine 104 and engine control 105 are specifically implemented, it will be appreciated that the diffuser 138 functions to slow the flow of the exhaust gas discharged by the gas turbine engine 104. The diffuser 138 additionally functions to promote exhaust flow distribution along the length of the main chamber 124 to better interact with the fluid (not shown in FIG. 1), such as wastewater, that is supplied to the inner volume 120 of the tank 102. It will be appreciated that the sides of the diffuser 138 may be disposed at any one of numerous angles relative to exhaust gas inlet port 132. In one particular embodiment, the sides are angled at about 5-degrees. However, this angle may vary as needed to meet desired performance characteristics.

In addition to the diffuser 138, additional structural features are included within the inner volume 120 of the tank 102 to further improve the distillation process implemented by the distillation system 100. A description of the additional structural features is not needed to enable the claimed invention. Thus, these additional structural features are not depicted in FIG. 1 and a description thereof will not be provided.

It should be noted that during operation of the distillation system 100, fluid within the main chamber 124 is maintained at or above a predetermined fluid level. Although various techniques could be used to maintain the fluid within the main chamber 124 at or above the predetermined fluid level, in the depicted embodiment, and as FIG. 1 further depicts, the distillation system 100 may additionally include at least a fluid source 142 and a fluid pump 144.

The fluid source 142, which may be variously configured, is the source of the fluid that is to be distilled by the distillation system 100. The fluid pump 144 is disposed between, and is in fluid communication with, the fluid source 142 and the main chamber 124. The fluid pump 144, which may be implemented using any one of numerous known fluid pumps, is configured to maintain the fluid within the main chamber 124 at or above the predetermined fluid level. It will be appreciated that in some embodiments, the distillation system 100 may also include a non-illustrated fluid level sensor. The fluid level sensor, when included, may be disposed on or within the tank 102 and is configured to sense the fluid level within the main chamber 124 and supply a fluid level signal to the fluid pump 144.

The distillation system 100 also includes a valve 146, a pressure sensor 148, and a valve control 152. The valve 146 is mounted on the exhaust gas outlet port 134 and is configured, in response to valve commands, to move between a closed position and a plurality of open positions. In the closed position, the settling chamber 126 is isolated from the ambient environment external to the tank 102. In any one of the plurality of open positions, the settling chamber 126 is in fluid communication with the ambient environment. Although the valve 146 may be configured to fail open, fail shut, or fail as-is, in the depicted embodiment it is configured to fail open. That is, the valve 146 is configured, in response to receiving no valve commands (e.g., loss of power), to move to an open position, and most preferably the full-open position. It will be appreciated that the valve 146 may be implemented using any one of numerous types of electrically-actuated, pneumatically-actuated, or hydraulically-actuated valves. In one embodiment, however, it is implemented using an electrically-actuated valve plate.

The pressure sensor 148 is coupled to the tank 102. The pressure sensor 148 is configured to sense the pressure within the inner volume 120 of the tank 102 and to supply a pressure sensor signal representative thereof. The pressure sensor 148 in the depicted embodiment is located within the settling chamber 126. It will be appreciated, however, that it could, in some embodiments, be located in the main chamber 124. It will be appreciated that the pressure sensor 148 may be implemented using any one of numerous types of pressure sensors.

The valve control 152 is in operable communication with the pressure sensor 148 and the valve 146. The valve control 152 is coupled to receive the pressure sensor signal from the pressure sensor 148 and is configured to supply the valve commands to the valve 146 based at least in part on the pressure sensor signal, thereby controlling the pressure within the inner volume 120. Preferably, the valve control 152 is additionally configured to command the valve 146 to an open position during startup of the gas turbine engine 104 and during shutdown of the gas turbine engine 104. In this way, pressure within the tank inner volume 120 is relieved and the gas turbine engine 104 does not experience any back pressure during these operations. Thus, as FIG. 1 further depicts, to facilitate this functionality the valve control 152 may also be in operable communication with the engine control 105. Although the valve control 152 and engine control 105 are depicted in FIG. 1 using separate functional blocks, it will be appreciated that the valve control 152 and the engine control 105 may be integrally formed and/or may be disposed within a common housing.

To provide increased accuracy in controlling the evaporation rate within the tank 102, the distillation system 100 may additionally include a temperature sensor 154. The temperature sensor 154, when included, is coupled to the tank 102, and is configured to sense the temperature within the inner volume 120 of the tank 102 and supply a temperature sensor signal representative thereof to the valve control 152. The valve control 152, in these embodiments, is additionally coupled to receive the temperature sensor signal from the temperature sensor 154 and is further configured to supply the valve commands based additionally upon the temperature sensor signal.

One additional feature that the distillation system 100 may include, at least in some embodiments, is an exhaust shield 156. The exhaust shield 156, when included, is disposed downstream of the valve 146 and is configured to prevent hot air recirculation back to the inlet of the gas turbine engine 104.

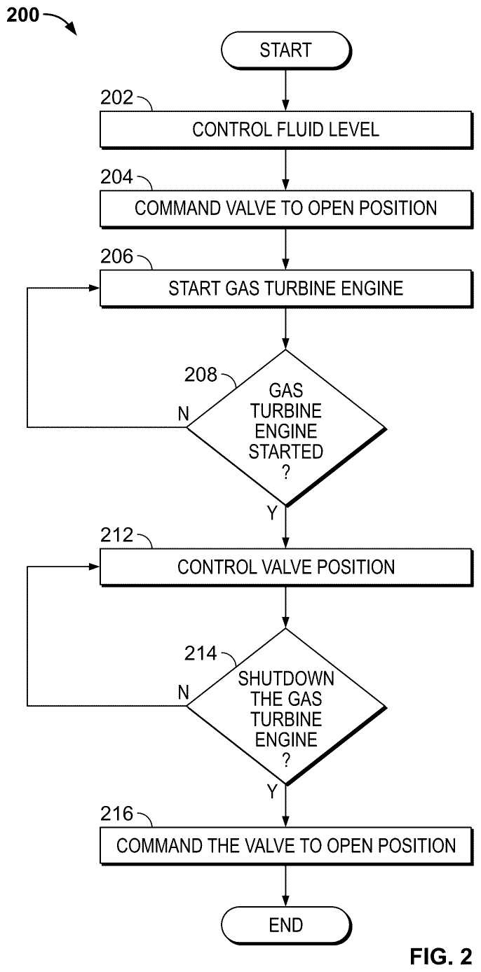

Having described the overall structure of the distillation system 100, the operation 200 of the distillation system 100 will now be briefly described. In doing so, reference should be made to FIGS. 1 and 2. Before the gas turbine engine 104 is started, the fluid pump 144 is operated to supply fluid, from the fluid source 142, to the tank 102, and is then used to maintain the fluid level at the predetermined fluid level (202). Thereafter, valve 146 is commanded to an open (preferably full-open) position (204) and the gas turbine engine 104 is started (206).

After the gas turbine engine 104 is started (208), the valve 146 is commanded, via the valve control 152, to the closed position. The exhaust gas that is discharged from the gas turbine engine 104 is directed, via the diffuser 138, into the main chamber 124 and begins heating and perturbing the fluid within the tank 102. As the pressure within the inner volume 120 of the tank increases, the valve control 152, based at least in part on the pressure sensor signal supplied from the pressure sensor 148, controls the pressure within the inner volume 120 by controlling the position of the valve 146 (212). As noted above, in some embodiments the valve control 152 additionally controls the position of the valve 146 based on the temperature sensor signal supplied from the temperature sensor 154.

When the distillation system 100 is ready for shutdown, the gas turbine engine 104 is commanded to shutdown (214) and, at the same time, the valve 146 is commanded to an open (preferably full-open) position (216). This prevents any potential fluid backflow into the gas turbine engine 104 due to pressure build-up within the tank 102.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

As used herein, the term “axial” refers to a direction that is generally parallel to or coincident with an axis of rotation, axis of symmetry, or centerline of a component or components. For example, in a cylinder or disc with a centerline and generally circular ends or opposing faces, the “axial” direction may refer to the direction that generally extends in parallel to the centerline between the opposite ends or faces. In certain instances, the term “axial” may be utilized with respect to components that are not cylindrical (or otherwise radially symmetric). For example, the “axial” direction for a rectangular housing containing a rotating shaft may be viewed as a direction that is generally parallel to or coincident with the rotational axis of the shaft. Furthermore, the term “radially” as used herein may refer to a direction or a relationship of components with respect to a line extending outward from a shared centerline, axis, or similar reference, for example in a plane of a cylinder or disc that is perpendicular to the centerline or axis. In certain instances, components may be viewed as “radially” aligned even though one or both of the components may not be cylindrical (or otherwise radially symmetric). Furthermore, the terms “axial” and “radial” (and any derivatives) may encompass directional relationships that are other than precisely aligned with (e.g., oblique to) the true axial and radial dimensions, provided the relationship is predominantly in the respective nominal axial or radial direction. As used herein, the term “substantially” denotes within 5% to account for manufacturing tolerances. Also, as used herein, the term “about” denotes within 5% to account for manufacturing tolerances.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A distillation system pressure control system, comprising:
a tank having a first end wall, a second end wall, a front wall, a back wall, a top wall, and a bottom wall that together define an inner volume, a divider wall disposed within the tank and dividing the inner volume into a main chamber and a settling chamber, the main chamber having at least a fluid inlet port and an exhaust gas inlet port, the settling chamber having at least an exhaust gas outlet port, the divider wall having an opening formed therein that provides fluid communication between the main chamber and the settling chamber;
a diffuser disposed within the main chamber and coupled to the exhaust gas inlet port, the diffuser adapted to receive exhaust gas discharged from a gas turbine engine;
a valve mounted on the exhaust gas outlet port and configured, in response to valve commands, to move between (i) a closed position, in which the settling chamber is isolated from an ambient environment external to the tank, and (ii) a plurality of open positions, in which the settling chamber is in fluid communication with the ambient environment;
a pressure sensor coupled to the tank, the pressure sensor configured to sense pressure within the inner volume and supply a pressure sensor signal representative thereof; and
a valve control in operable communication with the pressure sensor and the valve, the valve control coupled to receive the pressure sensor signal from the pressure sensor and configured to supply the valve commands to the valve based at least in part on the pressure sensor signal, to thereby control the pressure within the inner volume.

2. The system of claim 1, further comprising:
a temperature sensor coupled to the tank, the temperature sensor configured to sense temperature within the inner volume and supply a temperature sensor signal representative thereof,
wherein the valve control is additionally coupled to receive the temperature sensor signal from the temperature sensor and is further configured to supply the valve commands based additionally upon the temperature sensor signal.

3. The system of claim 1, wherein the valve is commanded, via the valve control, to an open position during a startup of the gas turbine engine and during a shutdown of the gas turbine engine.

4. The system of claim 3, wherein:
the valve is configured, in response to receiving no valve commands, to move to an open position.

5. The system of claim 1, further comprising:
a gas turbine engine in fluid communication with the exhaust gas inlet port, the gas turbine engine configured, during operation thereof, to discharge the exhaust gas into the main chamber via the diffuser.

6. The distillation system of claim 5, further comprising:
an engine control in operable communication with the gas turbine engine, and configured to control the operation of the gas turbine engine.

7. The distillation system of claim 6, wherein the valve control and the engine control are integrally formed.

8. The distillation system of claim 6, wherein the valve control and the engine control are disposed within a common housing.

9. The distillation system of claim 1, further comprising an exhaust shield coupled to the tank and disposed downstream of the valve.

10. A distillation system pressure control system, comprising:
a tank having a first end wall, a second end wall, a front wall, a back wall, a top wall, and a bottom wall that together define an inner volume, a divider wall disposed within the tank and dividing the inner volume into a main chamber and a settling chamber, the main chamber having at least a fluid inlet port and an exhaust gas inlet port, the settling chamber having at least an exhaust gas outlet port, the divider wall having an opening formed therein that provides fluid communication between the main chamber and the settling chamber;
a diffuser disposed within the main chamber and coupled to the exhaust gas inlet port;
a gas turbine engine in fluid communication with the exhaust gas inlet port, the gas turbine engine configured, during operation thereof, to discharge exhaust gas into the main chamber via the diffuser;
a valve mounted on the exhaust gas outlet port and configured, in response to valve commands, to move between (i) a closed position, in which the settling chamber is isolated from an ambient environment external to the tank, and (ii) a plurality of open positions, in which the settling chamber is in fluid communication with the ambient environment;
a pressure sensor coupled to the tank, the pressure sensor configured to sense pressure within the inner volume and supply a pressure sensor signal representative thereof;
a temperature sensor coupled to the tank, the temperature sensor configured to sense temperature within the inner volume and supply a temperature sensor signal representative thereof; and
a valve control in operable communication with the pressure sensor, the temperature sensor, and the valve, the valve control coupled to receive the pressure sensor signal from the pressure sensor and the temperature sensor signal from the temperature sensor and configured to supply the valve commands to the valve based at least in part on the pressure sensor signal and the temperature sensor signal, to thereby control the pressure within the inner volume.

11. The system of claim 10, wherein the valve is commanded, via the valve control, to an open position during a startup of the gas turbine engine and during a shutdown of the gas turbine engine.

12. The system of claim 11, wherein:
the valve is configured, in response to receiving no valve commands, to move to an open position.

13. The distillation system of claim 10, further comprising:
an engine control in operable communication with the gas turbine engine and configured to control the operation of the gas turbine engine.

14. The distillation system of claim 13, wherein the valve control and the engine control are integrally formed.

15. The distillation system of claim 13, wherein the valve control and the engine control are disposed within a common housing.

16. The distillation system of claim 10, further comprising an exhaust shield coupled to the tank and disposed downstream of the valve.

17. A method of controlling pressure in a distillation system that comprises a tank, a diffuser, a gas turbine engine, and a valve, wherein (i) the tank has a first end wall, a second end wall, a front wall, a back wall, a top wall, and a bottom wall that together define an inner volume, a divider wall disposed within the tank and dividing the inner volume into a main chamber and a settling chamber, the main chamber having at least a fluid inlet port and an exhaust gas inlet port, the settling chamber having at least an exhaust gas outlet port, the divider wall having an opening formed therein that provides fluid communication between the main chamber and the settling chamber, (ii) the diffuser is disposed within the main chamber and is coupled to the exhaust gas inlet port, (iii) the gas turbine engine is in fluid communication with the exhaust gas inlet port and is configured, during operation thereof, to discharge exhaust gas into the main chamber via the diffuser, and (iv) the valve is mounted on the exhaust gas outlet port and movable to a valve position, and wherein the method comprises the steps of:
sensing pressure within the inner volume of the tank via a pressure sensor that is coupled to the tank; and
controlling, via a valve control in operable communication with the pressure sensor and the valve, the position of the valve based at least in part on the pressure sensor signal, to thereby control the pressure within the inner volume.

18. The method of claim 17, further comprising:
sensing temperature within the inner volume via a temperature sensor that is coupled to the tank and is in operable communication with the valve control; and
controlling, via the valve control, the position of the valve based additionally upon the temperature sensor signal.

19. The method of claim 17, further comprising:
commanding the valve, via the valve control, to an open position during a startup of the gas turbine engine and during a shutdown of the gas turbine engine.
